(19) United States
(12) Patent Application Publication
(10) Pub. No.: US 2006/0266120 A1
(43) Pub. Date: Nov. 30, 2006

(54) Method and a system for determining the component of tyre-road noise in the total noise in the interior of a vehicle

(75) Inventors: Matthias Riegel, Filderstadt (DE); Martin Helfer, Sindelfingen (DE)

Correspondence Address: Lipsitz & McAllister, LLC, 755 MAIN STREET, MONROE, CT, 06468, US

(73) Assignee: Forschungsinstitut fuer Kraftfahrwesen und Fahrzeugmotoren Stuttgart (FKFS), Stuttgart (DE)

(21) Appl. No.: 11/257,754

(22) Filed: Oct. 24, 2005

(30) Foreign Application Priority Data
Mar. 11, 2005 (DE) 102005012702.9-52

(51) Int. Cl. G01H 1/00

(52) U.S. Cl. 73/587

(57) ABSTRACT

In order to provide a method for determining the component of noise which results from the rolling of at least one wheel of a vehicle on a roadway in the total noise in the interior of a vehicle with the aid of which method a noise component of the tyre-roadway noise within the total noise in the interior of a vehicle can be determined in a simple manner, it is proposed that the vehicle that is to be measured on which there is arranged at least one wheel and also at least one recording of the tyre rolling noise be made available, that the recording of the tyre rolling noise be reproduced in the vicinity of at least one wheel arranged on the vehicle being measured, and that the noise component that is to be determined be measured at at least one internal spatial point in the interior of the vehicle during the reproduction of the recording of the tyre rolling noise. Furthermore, there is also proposed a system for determining the component of noise which results from the rolling of a wheel the vehicle on a roadway in the total noise in the interior of a vehicle.

The present disclosure relates to the subject matter disclosed in German patent application 10 2005 012 702.9-52 of Mar. 11, 2005 which is incorporated herein by reference in its entirety and for all purposes.

### BACKGROUND OF THE INVENTION

The present invention relates to a method for determining a noise component, which results from the rolling of at least one wheel of a vehicle on a roadway, in the total noise in the interior of a vehicle.

Furthermore the present invention relates to a system for determining a noise component, which results from the rolling of a wheel of the vehicle on a roadway, in the total noise in the interior of a vehicle.

In recent years, numerous vehicle manufacturers have succeeded in lowering the noise level in the interior of a vehicle to a significant extent thereby increasing passenger comfort. The acoustics in the interior of the vehicle under all operating conditions form an important purchasing criterion, and more particularly, in the case of vehicles in the upper middle class and the upper class.

Various sources of noise or sound contribute to the total noise in the interior of a vehicle, and in particular thereby, these are the components derived from the engine and transmission noises, rolling noises, tyre-roadway noises and wind noises, whereby the respective component can vary greatly under different boundary conditions. Hereby and in particular at high speeds, a large component is attributable to the noise made by a tyre on the roadway which is referred to hereinafter as tyre rolling noise. For the vehicle manufacturers, it is therefore of special interest to know under which operating conditions and in which frequency ranges the vehicle acoustics or the noise level in the interior are dominated by the tyre-roadway noise.

It is known to measure the tyre-roadway noise on a roller type test stand although it is not possible using this type of procedure to separate the rolling noise produced by the body shell and the noise produced by the tyre on the roadway. Furthermore hereby, the inherent noise of the driving rollers can also adversely affect the result of the measurement.

### SUMMARY OF THE INVENTION

Consequently, the object of the present invention is to provide a method and a system of the type described hereinabove with the aid of which a component of the noise arising from the tyre-roadway noise in the total noise in the interior of a vehicle can be determined in a simple manner.

In accordance with the invention, this object is achieved in the case of a method of the type described hereinabove in that it comprises the following steps:
making available the vehicle being measured on which there is arranged at least one wheel,
making available at least one recording of the tyre rolling noise,
reproducing the recording of the tyre rolling noise in the vicinity of at least one wheel arranged on the vehicle being measured and
measuring the noise component that is to be determined at at least one internal spatial point in the interior of the vehicle during the reproduction of the recording of the tyre rolling noise.

In principle, the proposed method in accordance with the invention enables the noise component of the tyre rolling noise in the interior of a vehicle to be determined directly, namely, without having to move the vehicle. To this end, a recorded, for example, speed-dependent tyre rolling noise is reproduced in the vicinity of one or all of the wheels of the vehicle being measured. The reproduction can, in principle, be effected simultaneously or successively for all of the wheels or it may be subjected to a time delay, for example, delayed by a few fractions of a second. If the method is carried out in a sound-absorbing room in which no other noises are otherwise produced, the noise component being sought can be measured directly and thus it can be measured separately from all other sources of noise in the moving vehicle using the method in accordance with the invention.

It is advantageous, if the recording of the tyre rolling noise is produced by recording real or simulated rolling noises which occur in the vicinity of the test wheel during the real or simulated rolling of a real or simulated test wheel on a real or simulated roadway. For example, the recording of the tyre rolling noise can be made in speed dependent manner for a certain test wheel which corresponds to the wheel or the wheels being used on the vehicle. In addition, the recording of the tyre rolling noise can be produced using different tyres on a plurality of different roadways. In exactly the same manner, recordings of the tyre rolling noise can also be produced from simulated rolling noises which can be computed on the basis of real rolling noises. In each case, a collection or a data base of a plurality of recordings of the tyre rolling noise can be produced in a simple manner.

In order to enable the noise component of the tyre-roadway noise in the interior to be determined in dependence on the speed, it is expedient for the recording of the tyre rolling noise to be produced by recording rolling noises in dependence on the rolling speed of the test wheel on the roadway. The speed range in which the noise component of the tyre-roadway noise in the interior has the greatest influence on the total noise in the interior can thus be directly determined.

It is expedient for the purposes of rolling on the real roadway, if the real test wheel is mounted in freely rotatable manner in a tyre noise measuring trailer and the tyre noise measuring trailer is moved on the roadway, whereby the test wheel is in contact with the roadway. The recording of the tyre rolling noise can thus be effected in that an individual test wheel is moved in rolling manner on a roadway. The recording of the rolling noises can be effected in analogue or digital manner and stored on appropriate storage media. Preferably, the test wheel is arranged in the tyre noise measuring trailer in a sound-absorbing housing so that only the rolling noises actually produced by the test wheel but no interfering noises are recorded.

Advantageously, for the production of the recording of the tyre rolling noise, at least one sound pressure sensor is used for measuring a prevailing sound pressure. The sound pressure can be measured by the sound pressure sensor in the vicinity of the rolling test wheel, i.e. in a near-tyre field. This preferably happens at characteristic positions. It is advantageous hereby, if, for different combinations of tyres and roadways, the sound pressure sensor is always arranged at the same place and the sound pressure is determined at this place. It is self-evident that a plurality of sound pressure sensors could also be arranged in the near-tyre field for the purposes of producing the recording of the tyre rolling noise. One position of the sound pressure sensor thus forms a parameter for each recording of the tyre rolling noise.

It is advantageous, if, for the recording of the tyre rolling noise, at least one sound pressure sensor is arranged on an outer side of the test wheel. The sound pressure sensor is preferably arranged at the height of the side-wall of the tyre directly above the roadway.

Furthermore, it can be expedient for the recording of the tyre rolling noise, if at least one sound pressure sensor is arranged in front of the test wheel. Self-evidently, such an arrangement also comprises the arrangement of a sound pressure sensor at the run-in area of the tyre, relatively close to the roadway, in order to enable the sound radiated in the direction of travel to be determined directly.

Furthermore, it can be expedient for the recording of the tyre rolling noise, if at least one sound pressure sensor is arranged behind the test wheel. The placement of the sound pressure sensor at the run-off area of the tyre, preferably relatively close to the roadway, enables the sound emitted in a direction opposite to the direction of travel to be detected directly, such sound resulting in particular from the vibrations of the tread pattern blocks of a tyre on the wheel.

The execution of the method is particularly simple, if a microphone is used as the sound pressure sensor. An acoustic recording of the sound produced can be effected directly by the use of a microphone.

In order to enable the recording of the tyre rolling noise thereby produced to be used for several vehicles, it is expedient for it to be stored on a storage medium. For example, the storage medium can be a digital storage medium such as, in particular, a CD, a DVD or a data tape or else an analogue storage medium such as an audio recording tape or an audio cassette for example.

In accordance with a preferred variant of the method in accordance with the invention, provision may be made for the recording of the tyre rolling noise to be produced in the form of a real or simulated test sound field data record and for the test sound field data record to contain data for at least one spatial point of the test sound field in the vicinity of the test wheel rolling on a roadway for the purposes of describing the test sound field produced in the vicinity of the test wheel by the rolling of the test wheel on the roadway. The provision of the recordings of the tyre rolling noise in the form of real or simulated data records enables the recordings to be processed, in particular, by means of a data processing device. The data records can thus be duplicated in a simple manner or else they can be reproduced successively or in time-delayed manner. Furthermore, it is also possible to standardize or to calibrate the data records in a simple manner in the event that the originally recorded sound pressure cannot be produced during the reproduction of the recording of the tyre rolling noise.

Preferably, the test sound field data record contains data for describing the sound pressure of the test sound field prevailing at the at least one spatial point of the test sound field. In particular, the sound pressure can be recorded for one or more spatial points of the test sound field in time and speed dependent manner.

It is expedient if a simulation sound field in the vicinity of the at least one wheel arranged on the vehicle being measured and an internal sound field in the interior of the vehicle are produced by the reproduction of the recording of the tyre rolling noise and if the noise component that is to be determined is determined by measuring the internal sound field at the at least one internal spatial point. A sound field is again produced by the reproduction of the recording of the tyre rolling noise, whereby the sound produced can penetrate through the body of the vehicle into the interior. In accordance with the invention, the noise component being sought is then determined at an arbitrary internal spatial point. In particular, the entire internal sound field that ensues as a result of the tyre-roadway noise can be measured by selecting a multiplicity of internal spatial points and measuring the noise component prevailing at these points.

The simulation sound field can be produced in a particularly simple manner by means of at least one tyre rolling noise reproduction device which is arranged in the vicinity of the at least one wheel.

In order to make the simulation sound field as similar as possible to the test sound field, it is advantageous if at least one tyre rolling noise reproduction device is arranged in such a manner that the sound produced during the reproduction of the recording of the tyre rolling noise is radiated outwardly from the at least one wheel in a direction transverse to the direction of travel. For example, the test sound field recorded laterally of the side-wall of a tyre can be well imitated in this manner.

Furthermore, it is expedient if at least one tyre rolling noise reproduction device is arranged in such a manner that the sound produced during the reproduction of the recording of the tyre rolling noise is radiated away from the at least one wheel in the direction of travel. A sound field in the run-in area of the tyre can be reproduced very accurately in this manner.

Moreover, it can be advantageous if at least one tyre rolling noise reproduction device is arranged in such a manner that the sound produced during the reproduction of the recording of the tyre rolling noise is radiated away from the at least one wheel in a direction opposite to the direction of travel. A sound field within the run-off area of the tyre can be imitated such as to be virtually identical to the original in this manner.

Preferably, three or four tyre rolling noise reproduction devices per wheel are used. In this way for example, sound fields in the run-in area of the tyre, in the run-off area of the tyre and laterally of one or both side-walls of the tyre can also be imitated simultaneously if such should be desired.

It is expedient if a point-like emitter or a substantially point-like emitter is used as the tyre rolling noise reproduction device. The recorded test sound field can be converted thereby into a virtually identical simulation sound field.

It is advantageous for a loudspeaker to be used as the tyre rolling noise reproduction device. The method can be carried out very economically in this way. In addition, the simulation sound field can be produced in such a manner that it corresponds to the test sound field by appropriate choice of a suitable loudspeaker.

In accordance with a preferred variant of the method in accordance with the invention, provision may be made for the reproduction of the recording of the tyre rolling noise to be recorded in the form of a recording of the reproduction of the tyre rolling noise and for the reproduction of the recording of the tyre rolling noise to be calibrated in such a manner that the recording of the reproduction of the tyre rolling noise is in correspondence with the recording of the tyre rolling noise. By virtue of this manner of procedure, it can be ensured that the sound produced under the vehicle, which is preferably located in a sound-absorbing room, corresponds to that which actually occurs during the rolling of the wheel on a certain type of roadway.

It is advantageous, if the calibration of the recording of the reproduction of the tyre rolling noise is carried out using a wheel and if the wheel is arranged on the vehicle for the calibration process. If the calibration is carried out in such a manner, then it is expedient if the test wheel is surrounded by a wheel housing shell during the production of the recording of the tyre rolling noise, said wheel housing shell corresponding to a wheel housing shell of the vehicle being measured.

The calibration of the recording of the reproduction of the tyre rolling noise is particularly simple, if it is carried out using a wheel and if the wheel is removed from the vehicle for the calibration process. In this way, conditions identical to those prevailing during the production of the recording of the tyre rolling noise are established. To this end, a wheel is merely arranged in a sound-absorbing room and the recording of the tyre rolling noise is reproduced whilst simultaneously making a recording of this reproduction of the tyre rolling noise. A recording of the reproduction of the tyre rolling noise which is calibrated in such a manner, in particular, for a certain reproduction device, can then be used for the acoustic irradiation of all the wheels. In principle, a subsequent calibration is then no longer necessary when using identical reproduction devices.

In order to facilitate the processing of the recording of the reproduction of the tyre rolling noise by means of a data processing arrangement, it is expedient for the recording of the reproduction of the tyre rolling noise to be produced in the form of a calibration sound field data record which, for the purposes of describing the simulation sound field, contains data for at least one spatial point of the simulation sound field in the vicinity of the wheel. Thus for example, the simulation sound field can be compared in a simple manner with the test sound field if this is likewise present in the form of a data record.

It is expedient for the production of the recording of the reproduction of the tyre rolling noise if at least one simulation sound field sound pressure sensor is used for measuring a sound pressure prevailing at at least one spatial point of the simulation sound field in the simulation sound field. The simulation sound field can be measured at desired points in a simple manner with the aid of one or more simulation sound field sound pressure sensors.

In order to enable a check to be made as to whether the simulation sound field is in correspondence with the test sound field in a particularly simple manner, it is advantageous if the at least one spatial point of the simulation sound field has the same spatial relationship relative to the wheel as does the at least one spatial point of the test sound field relative to the test wheel.

Advantageously, the tyre rolling noise reproduction device is calibrated by altering the simulation sound field until the calibration sound field data record corresponds to the test sound field data record. In particular, such a calibration of the tyre rolling noise reproduction device can be carried out automatically using a servo-loop arrangement and with the help of a data processing device.

Expediently, the at least one simulation sound field sound pressure sensor is arranged in the same spatial relationship relative to the wheel as is the at least one sound pressure sensor relative to the test wheel. In this way, it can be ensured that a simulation sound field that is as identical as possible to the test sound field is produced by means of a calibration process.

The noise component of the tyre-roadway noise can be determined even more precisely, if the at least one simulation sound field sound pressure sensor and the at least one sound pressure sensor are identical or of similar construction. It therefore follows that equivalent sound pressures then lead to like signals.

Advantageously, three or four sound pressure sensors and three or four simulation sound field sound pressure sensors are used, preferably for each wheel. In consequence, the sound field in the run-in area of the tyre, in the run-off area of the tyre and at one or both side-walls of the tyre can be measured with a sufficient degree of accuracy.

In order to enable the determined noise components to be easily and rapidly compared, in particular, with the noise components of other vehicles, it is advantageous if an internal sound field data record is produced which contains data for describing the internal sound field at the at least one internal spatial point.

In order to avoid unwanted resonances or superimposition effects in the interior in the course of the measurement of the noise component of all the wheels of the vehicle, it is expedient for the reproduction of the recording of the tyre rolling noise to be carried out successively in the vicinity of all the wheels of the vehicle, for an internal noise component to be determined thereby individually for each wheel, and for the noise component requiring determination to be determined by the addition of the internal noise components of the individual wheels. Thus, a separate measurement can be carried out for each wheel, whereby the individual results of the measurements are added to form the total result. However, it would also be conceivable for the recording of the tyre rolling noise to be reproduced just slightly delayed in time for the wheels of the vehicle, for example a delay in the sub-second range, so that unwanted superimposition of the then identical signals cannot occur.

In accordance with a further preferred variant of the method in accordance with the invention, provision may be made for the reproduction of the recording of the tyre rolling noise to be carried out simultaneously in the vicinity of at least two wheels of the vehicle, for an internal noise component to be determined thereby for the at least two wheels together, and for the noise component requiring determination and resulting from all of the wheels to be determined by the addition of the internal noise components of the at least two wheels. In the case of four wheels for example, all four wheels could be exposed to sound simultaneously and thus the internal noise component of the tyre-roadway noise for all the wheels can be determined directly. However, it would also be conceivable for the measurement to be carried out in each case for two pairs of wheels, or else for the measurement to be carried out together in each case for another number of wheels. This thus means for example, that two pairs of wheels are measured successively and their noise components are then added together in each case.

In order to determine the noise component at particular predestined positions in the vehicle, it is expedient for the at least one internal spatial point to correspond to the position of the left ear of the front-seat passenger or the position of the right ear of the driver. The sound pressure actually reaching the ears of the driver or the front seat passenger due to the simulation sound field can thus be determined.

Advantageously, a vehicle having four wheels is provided.

Expediently, identical wheels are arranged on the vehicle. The recording of the tyre rolling noise of the test wheel can thus be used for the simulation of the tyre-roadway noise for all four wheels in an identical manner.

In principle, it would also be conceivable for a non-powered wagon, a trailer or a railway truck for example, to be used as the vehicle. Preferably however, a motor vehicle is used as the vehicle. Due to the plurality of very starkly varying types of tyre available on the market and to the very varied types of roadway, it then becomes possible to select the optimal tyre for a plurality of different motor vehicles by preparing different recordings of the tyre rolling noise, such a tyre then resulting in the smallest component of tyre-road noise in the total internal noise in the interior of the vehicle. It would also be conceivable for the method to be carried out for a vehicle without an interior, for example, a bicycle or a two-wheeler.

In order to enable the “quietest” tyre for a certain vehicle to be selected, it is advantageous for a plurality of different recordings of the tyre rolling noise to be produced for different combinations of test wheels and roadways.

Furthermore, it is expedient for the test wheel or a wheel of similar construction to the test wheel to be used as the at least one wheel. However, it would also be conceivable to use another wheel as the test wheel although it should preferably be of the same dimensions as the test wheel.

Furthermore, in accordance with the invention, the object stated above is achieved by a system of the type described hereinabove in that the system comprises at least one recording of the tyre rolling noise, a tyre rolling noise reproduction device for reproducing the recording of the tyre rolling noise in the vicinity of at least one wheel arranged on the vehicle being measured and a measuring device for measuring the noise component that is to be determined at at least one internal spatial point in the interior of the vehicle during the reproduction of the recording of the tyre rolling noise. With the aid of the system in accordance with the invention for example, each of the methods in accordance with the invention that were described above can be carried out in problem-free manner. In particular, the noise component produced by the tyre-roadway noise in the interior of the vehicle can be directly measured by means of a system arranged in a sound-absorbing room without any other background noises.

Advantageously, the system comprises a tyre rolling noise recording device for producing the recording of the tyre rolling noise by recording real or simulated rolling noises which occur in the vicinity of the test wheel during the real or simulated rolling of a real or simulated test wheel on a real or simulated roadway. The tyre rolling noise recording device may comprise, in particular, a data processing arrangement with the aid of which the rolling noises can, for example, be recorded, processed and stored. Alternatively or in addition thereto, the recording device could also comprise an analogue device for recording the noises, for example, a cassette recorder or a tape recorder.

In accordance with a preferred embodiment of the invention, provision may be made for the recording of the tyre rolling noise to be producible with the aid of the tyre rolling noise recording device by recording the rolling noises in dependence on the rolling speed of the test wheel on the roadway. In consequence, a speed-dependent recording of the tyre rolling noise can be produced, whereby the noise component of the tyre-roadway noise in the interior of the vehicle can be determined directly in speed dependent manner.

Expediently, the tyre rolling noise recording device comprises a tyre noise measuring trailer in which the real test wheel is adapted to be mounted in freely rotatable manner for the purposes of rolling on the real roadway. Hereby, provision may advantageously be made for the tyre noise measuring trailer to comprise a sound-absorbing housing in order to prevent interfering noises from also being recorded.

In order to enable the tyre-roadway noise to be measured in the desired manner, it is advantageous for the tyre rolling noise recording device to comprise at least one sound pressure sensor for measuring a prevailing sound pressure.

In order to enable the sound pressure that is produced by the tyre when it is rolling along to be measured in the region of a side-wall of the tyre, it is advantageous for the at least one sound pressure sensor to be arranged on an outer side of the test wheel.

The sound field in the run-in area of the tyre which results from the rolling of the tyre can be measured in a particularly effective manner if the at least one sound pressure sensor is arranged in front of the test wheel.

The sound field within the run-off area of the tyre that is produced by the rolling of the tyre can be measured in a particularly effective manner if the at least one sound pressure sensor is arranged behind the test wheel.

The structure of the system is particularly simple if the at least one sound pressure sensor is a microphone. In particular, an acoustic signal can be picked up directly with the aid of a microphone.

Advantageously, the system comprises at least one storage medium for storing the recording of the tyre rolling noise that has been produced. Consequently, the recordings of the tyre rolling noise can be archived in a simple manner.

Preferably, the system comprises a data processing arrangement for the recording, reproduction and/or processing of the at least one recording of the tyre rolling noise.

So that both analogue and digital noise data can be processed by the system, it is expedient for the system to comprise at least one converter unit with the aid of which analogue noise data is convertible into digital noise data and/or vice versa.

In accordance with a further preferred embodiment of the invention, provision may be made for the at least one tyre rolling noise reproduction device to be arranged in such a manner that the sound produced during the reproduction of the recording of the tyre rolling noise is radiated outwardly from at least one wheel in a direction transverse to the direction of travel. In consequence, the sound that is produced in the vicinity of a side-wall of the tyre by the wheel during the rolling thereof can be imitated in a simple manner.

It is advantageous if at least one tyre rolling noise recording device is arranged in such a manner that the sound produced during the reproduction of the recording of the tyre rolling noise is radiated away from the at least one wheel in the direction of travel. A sound field within the run-in area of the tyre can be simulated in this way.

It is expedient for at least one tyre rolling noise reproduction device to be arranged in such a manner that the sound produced during the reproduction of the recording of the tyre rolling noise is radiated away from at least one wheel in a direction opposite to the direction of travel. Thus, a sound field within the run-off area of the tyre can be simulated in a simple manner.

In order to obtain measurement results which are as reproducible as possible, it is advantageous if there are provided three or four tyre rolling noise reproduction devices per wheel. These preferably radiate sound in three mutually independent directions.

The real tyre-roadway noises can be imitated in a particularly effective manner if the at least one tyre rolling noise-reproduction device comprises a point-like emitter or a substantially point-like emitter.

The construction of the system can be simplified still further if the at least one tyre rolling noise recording device comprises a loudspeaker.

In order to generate the sound field produced by the tyre rolling noise recording device in such a way that it is in correspondence with the sound field underlying the recording of the tyre rolling noise, it is expedient for the system to comprise a recording device for the reproduced tyre rolling noise for recording the reproduction of the recording of the tyre rolling noise in the form of a recording of the reproduction of the tyre rolling noise and for a calibration unit to be provided for calibrating the tyre rolling noise reproduction device so that the recording of the reproduction of the tyre rolling noise is in correspondence with the recording of the tyre rolling noise. Preferably, the calibration unit comprises a data processing device, an A/D converter and a D/A converter in order to convert analogue measuring signals into a digital form and vice versa. Preferably, a Fourier transform of the recordings is calculable with the aid of the calibration unit in order to produce a frequency dependent spectrum.

Advantageously, the system comprises at least one simulation sound field sound pressure sensor for the production of the recording of the reproduction of the tyre rolling noise.

In order to enable a calibration of the tyre rolling noise reproduction device to be effected in a particularly accurate manner, it is expedient for the at least one simulation sound field sound pressure sensor to be arranged with the same spatial relationship relative to the wheel as that of the at least one sound pressure sensor relative to the test wheel. If the sound pressures of all the simulation sound field sound pressure sensors are in correspondence with those of the sound pressure sensors, then one can assume that an optimum calibration of the tyre rolling noise reproduction device has been effected.

The calibration can be further improved, if the at least one simulation sound field sound pressure sensor and the at least one sound pressure sensor are identical or of similar construction.

Expediently, the system comprises an identical number of sound pressure sensors and simulation sound field sound pressure sensors, preferably three or four of each.

In accordance with a further preferred embodiment of the system in accordance with the invention, provision may be made for the measuring device to be arranged in the interior of the vehicle in such a manner that the noise component can be measured at a position which corresponds to the left ear of the front seat passenger or the right ear of the driver. In consequence, the noise component of the tyre-roadway noise that is effective on a driver or a front seat passenger can be measured directly.

Preferably, the vehicle comprises four wheels.

Expediently, identical wheels are arranged on the vehicle.

It would also be conceivable to investigate a railway truck, a bicycle or a motorized two-wheeler but it is expedient however, if the vehicle is a motor vehicle. An interior of the vehicle is not of compelling necessity for the employment of the system.

Furthermore, it is advantageous if the system comprises a plurality of different recordings of the tyre rolling noise incorporating noise data for different combinations of test wheels and test tracks. In consequence and without the need for extensive mechanical conversion work, different combinations of test wheels and roadways can be simulated on a vehicle in order to determine the respective noise component of the tyre-roadway noise in the total noise in the interior.

It is expedient for the at least one wheel to be the test wheel or a wheel that is of similar construction to the test wheel. Calibration errors can thus be assuredly avoided.

In accordance with a further preferred embodiment of the system, provision may be made for one of the methods described above to be carried with the aid of the system.

### BRIEF DESCRIPTION OF THE DRAWINGS

The following description of preferred embodiments of the invention serves, in conjunction with the drawing, for a more detailed explanation. In the drawing:

FIG. 1: shows a schematic illustration of the mechanisms giving rise to the tyre-roadway noise;

FIG. 2: an exemplary arrangement for the production of a recording of the tyre rolling noise;

FIG. 3: a schematic illustration of the calibration of a tyre rolling noise reproduction device;

FIG. 4: a schematic illustration of an alternative method of calibration for calibrating the tyre rolling noise reproduction device;

FIG. 5: a schematic illustration of the measurement of the noise component that is to be determined;

FIG. 6: an exemplary arrangement of sound pressure sensors relative to the test wheel in the tyre noise measuring trailer;

FIG. 7: an illustration of the arrangement of the sound pressure sensors for the calibration of the tyre rolling noise reproduction device in accordance with FIG. 3; and

FIG. 8: comparison spectra from a sound pressure sensor for the run-in area of the tyre in the case of a road and a test stand measurement (asphalt, 70 km/h).

### DETAILED DESCRIPTION OF THE DRAWINGS

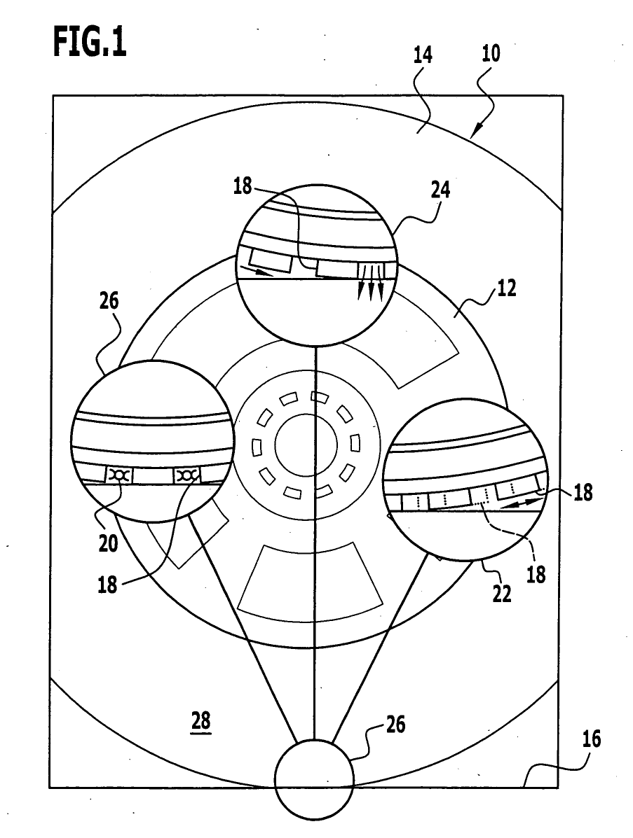

In FIG. 1 there is provided a schematic illustration of the way in which tyre-roadway noise can occur. The wheel 10 illustrated in FIG. 1 comprises a rim 12 and a tyre 14 which is mounted on the rim 12 and has a patterned running surface corresponding essentially to the surface of a cylinder.

The most important causes for the occurrence of the tyre-roadway noise are the radial and tangential vibrations of the elements of the tread pattern due to the impulsive forces occurring in a contact region 26 between the tyre 14 and the roadway 16 as well as aerodynamically induced mechanisms especially those such as the displacement of air in the grooves 18 in the tread pattern, the so-called “air pumping” and tread pattern resonances 20 which are symbolized in FIG. 1 by the standing waves depicted in the tread pattern grooves 18. The vibrations of the tread pattern elements occur predominantly in the run-off area of the tyre 22, the “air pumping” phenomenon chiefly arises in the run-in area of the tyre 24. The tread pattern resonances 20 are formed mainly in the contact region 26 between the tyre 14 and the roadway 16 and lead to the radiation of sound in a direction transverse to the direction of travel in the vicinity of the side-wall of a tyre 28.

The tyre-roadway noise is responsible above all for the external noise at medium to high speeds of travel and is, in particular, a dominant source of noise during the acceleration of a lorry. A large part of the tyre-roadway noise is prevented from reaching the interior 30 of a vehicle 32 by appropriate damping of the vehicle bodywork, the wheel housing, the end wall and the under-body of the vehicle. Absorbent materials used for the purposes of sound proofing in the interior 30 of the vehicle contribute to a further lowering of the internal noise.

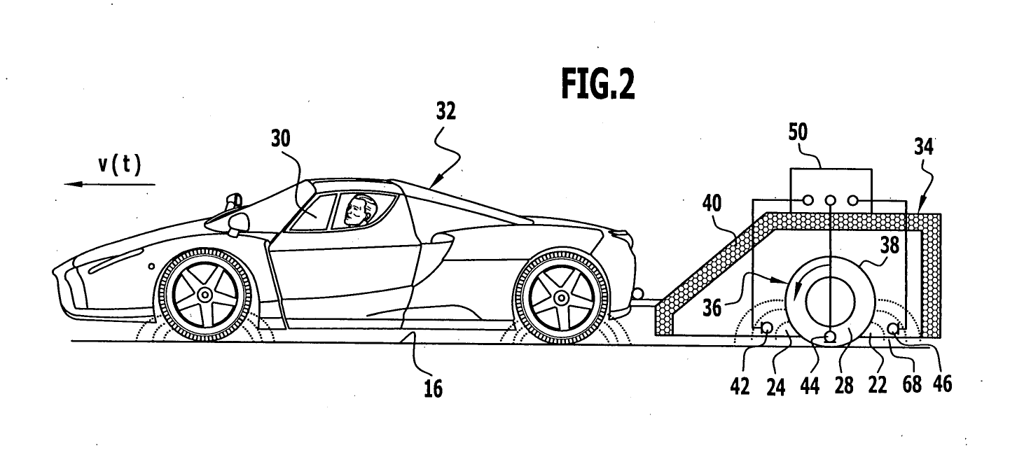

For the purposes of preparing at least one recording of the tyre rolling noise, a tyre noise measuring trailer 34 is used as is illustrated in FIG. 2, a test wheel 36 having a test tyre 38 being mounted in freely rotatable manner in said trailer. The tyre noise measuring trailer 34 comprises a housing 40 which is lined with a sound-absorbing material as well as three microphones 42, 44 and 46 which serve as sound pressure sensors. In one preferred embodiment, the microphone 42 is arranged at a height h₁=120 mm above the roadway 16 and at a distance d₁=100 mm in front of a surface of the tyre in the run-in area of the tyre. In a similar manner behind the test wheel 36, the microphone 46 is arranged at a height h₁=120 mm above the roadway 16 and at a distance d₁=100 mm from the run-off area of the tyre 22 behind the test wheel 36. The third microphone 44 serving as a sound pressure sensor is arranged laterally of the tyre side-wall 28 at a distance d₁=100 mm and at a height h₂=70 mm above the roadway 16. Furthermore, the tyre noise measuring trailer 34 carries a measuring unit 50 which is connected to the microphones 42, 44 and 46. The measuring unit 50 serves for the recording of the tyre rolling noise. This is recorded in dependence on the speed v, the type of tyre 14 and also the type of roadway 16. For this purpose, the tyre noise measuring trailer 34 is coupled to a vehicle 32 and moved at a speed v.

A noise reproduction unit 52 serves for the reproduction of the recording of the tyre rolling noise in the vicinity of the wheel 10 that is arranged on the vehicle being measured 32. This unit is in the shape of a square frustum of a pyramid wherein the inclined sides 54 of the frustum of a pyramid are inclined at approximately 30° relative to the base surface 56 thereof. A square upper surface 58 of the frustum of a pyramid extending in parallel with the base surface 56 serves as a standing surface for the wheel 10. Respective loudspeakers 60, 62 and 64 serving as tyre rolling noise reproduction devices are built-into three of the four sides 54, said loudspeakers being essentially in the form of point-like emitters and serving for the generation of a lobar simulation sound field 66.

The noise reproduction unit 52 is calibrated in order to ensure that the simulation sound field 66 is in correspondence as precisely as possible with the test sound field 68 that is produced by the test tyre 38 and is depicted schematically in FIG. 2. To this end, the noise reproduction unit 52 is placed in a sound-absorbing room 70 and the base surface 56 is laid on the floor 72 of the room. The wheel 10 is placed on the upper surface 58, namely, in such a manner that the loudspeaker 60 exposes a run-in area of the tyre 24 to sound and the loudspeaker 64 exposes a run-off area of the tyre 22 to sound. A sound field is simulated in the vicinity of the tyre side-wall 28 by the loudspeaker 62. Furthermore, three microphones 74, 76 and 78 serving as simulation sound field sound pressure sensors are arranged relative to the tyre 14 in the same manner as the microphones 42, 44 and 46 are arranged relative to the test tyre 38.

Advantageously, the wheel 10 corresponds to the test wheel 36. Moreover, the microphones 42, 44 and 46 as well as 74, 76 and 78 are identical.

For the purposes of calibrating the noise reproduction unit 52, the recording of the tyre rolling noise is played back via an amplifier 80 through the loudspeakers 60, 62 and 64, whereby the signal picked up by the microphone 42 is emitted via the loudspeaker 60, the signal which is picked up by the microphone 44 is emitted via the loudspeaker 62 and the signal picked up by the microphone 46 is emitted via the loudspeaker 64. The simulation sound field 66 is in turn measured by the microphones 74, 76 and 78. The signals are digitised by means of an (analogue-digital) A/D converter. Subsequently, the digital signal is converted by a Fourier transformation unit 84, a suitable computer program for this purpose for example, into a frequency spectrum 88 of the recording of the reproduction of the tyre rolling noise and compared with a frequency spectrum 86 of the recording of the tyre rolling noise which was determined previously. If the two frequency spectra 86 and 88 are not in correspondence, the emission from the respective loudspeakers 60, 62 and 64 is altered in a controlled manner by means of a regulating unit 90, for example, a third-octave band filter in the form of an equalizer for a multiplicity of frequency ranges. The output signal that has been altered by the regulating unit 90 is led via a (digital/analogue) D/A converter 92 back to the amplifier 80 which in turn drives the loudspeakers 60, 62 and 64. The calibration process described above is repeated until such time as the frequency spectra 86 and 88 coincide.

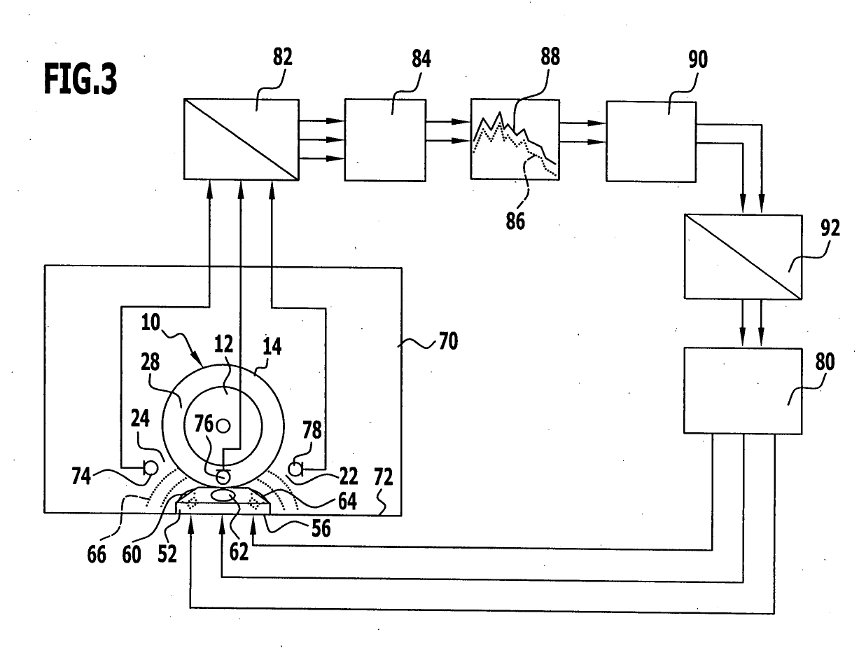

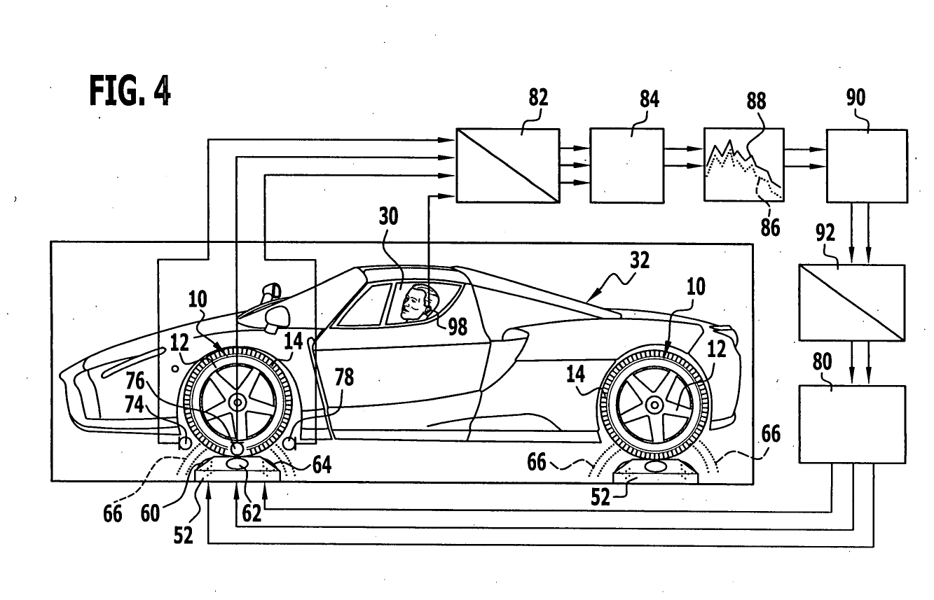

Alternatively, the noise reproduction unit 52 could also be calibrated when the wheel 10 is mounted on the vehicle 32. For this purpose as was described in conjunction with FIG. 3, the microphones 74, 76 and 78 are arranged in the vicinity of the wheel 10 in order to determine the simulation sound field 66 in an at least point-like manner. The frequency spectrum 86 of the recording of the tyre rolling noise is again compared with the frequency spectrum 88 of the recording of the reproduction of the tyre rolling noise and readjusted by the regulating unit 90 until such time as the frequency spectra 86 and 88 coincide.

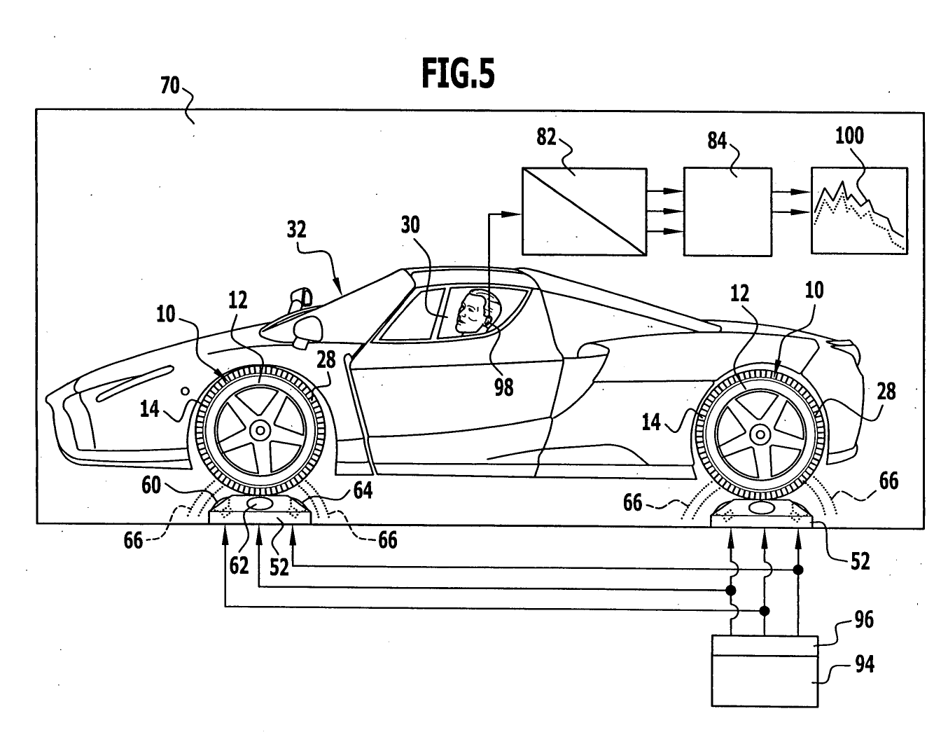

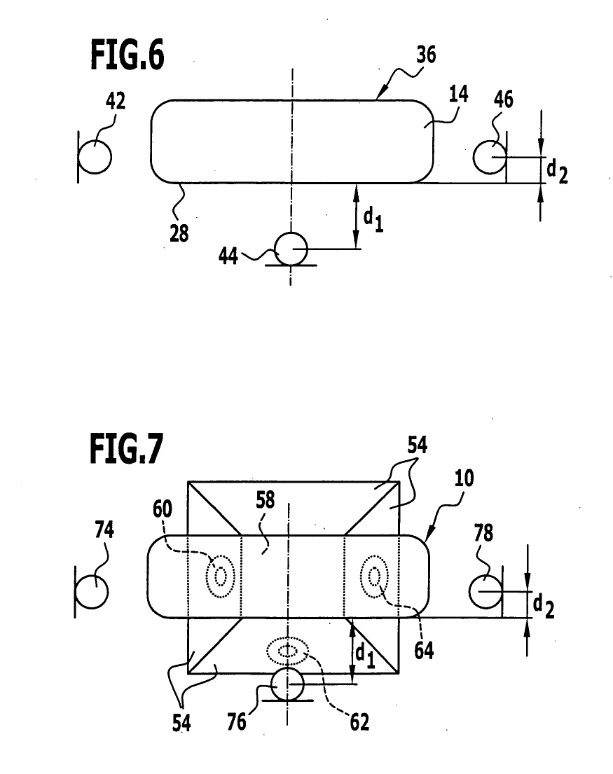

After the optimally effected calibration process, the actual measurement of the component of the noise 100 which results from the rolling of the wheels 10 of the vehicle 32 on the roadway 16 in the total noise in the interior 30 of the vehicle can be measured. For this purpose as is schematically illustrated in FIG. 5, an amplifier 96 that is preferably controlled by a computer 94 drives noise reproduction units 52, upon the surfaces 58 of which, there are located the wheels 10 that are mounted on the vehicle 32. The simulation sound field 66 calibrated as described above also leads to the propagation of sound in the interior 30 of the vehicle 32. As is exemplarily illustrated in FIG. 5, the noise component 100 that is to be determined is measured at the position of the left ear of the front seat passenger, namely, with the aid of a microphone serving as a measuring instrument. The signal produced in such a way is converted by an A/D converter 82 and by means of a Fourier transformation unit 84 into a frequency dependent spectrum of the noise component 100.

If the vehicle 32 is placed in a sound-absorbing room 70 prior to the execution of the simulation measurement, then the noise component 100 that is to be determined can be measured directly.

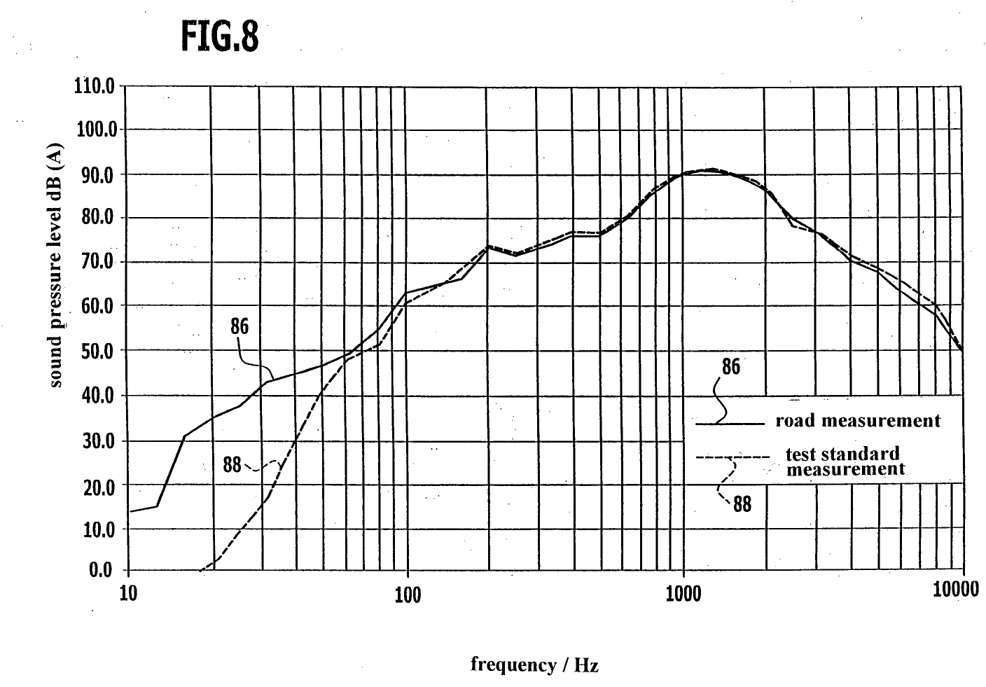

The comparison of two frequency spectra 86 and 88 that are associated with the microphones 42 and 74 is illustrated in FIG. 8 in exemplary manner. The recording of the tyre rolling noise was effected whilst travelling on an asphalt roadway at 70 km/h. There is a sufficiently high level of coincidence between the two spectra 86 and 88 over the entire frequency range. It is merely below the frequency of reproduction of the loudspeakers 60, 62 and 64, here, below approximately 60 Hertz, that there is a significant deviation between the frequency spectrum 86 of the recording of the tyre rolling noise and the frequency spectrum 88 of the recording of the reproduction of the tyre rolling noise.

For the purposes of determining the tyre-roadway noise in the interior 30, several variants are possible after the calibration process. In principle, the noise reproduction units 52 for each wheel 10 could be driven simultaneously so that the noise component 100 which all four wheels 10 contribute to the tyre-roadway noise in the interior 30 can be measured directly. It would also be conceivable to drive each noise reproduction unit 52 separately and then add up the respective noise components measured in the interior 30, for example, by addition of each of the frequency spectra obtained.

It is preferred that the four noise reproduction units 52 be driven in slightly time delayed manner, for example, using time delays within a range of from 0.2 to 0.8 seconds. The occurrence of a superimposition of the signals caused by the arrangement of the noise reproduction units 52 relative to the vehicle 32 that could impair the measurement can thereby be prevented.

Due to the size and power thereof, the loudspeakers 60, 62 and 64 are only suitable to a limited extent for simulating sound fields at higher speeds of travel and thus higher levels of sound pressure. In this case, the interior noise is determined by calculation after the determination of an airborne sound transfer function from each individual wheel to the measuring position in the vehicle 32. The airborne sound transfer function can be determined experimentally for low speeds of travel and thus lower levels of sound pressure so that the noise components in the interior 30 at higher speeds of travel can be determined by calculation from the measured, level-reduced frequency spectra.

1. A method of determining a noise component which results from the rolling of at least one wheel of a vehicle on a roadway, in the total noise in the interior of the vehicle, comprising the steps:
making available the vehicle being measured on which there is arranged at least one wheel,
making available at least one recording of the tyre rolling noise,
reproducing the recording of the tyre rolling noise in the vicinity of at least one wheel arranged on the vehicle being measured and
measuring the noise component that is to be determined at at least one internal spatial point in the interior of the vehicle during the reproduction of the recording of the tyre rolling noise (86).

2. A method in accordance with claim 1, characterized in that the recording of the tyre rolling noise is produced by recording real or simulated rolling noises which occur during the real or simulated rolling of a real or simulated test wheel on a real or simulated roadway in the vicinity of the test wheel.

3. A method in accordance with claim 2, characterized in that the recording of the tyre rolling noise is produced by recording rolling noises in dependence on the rolling speed of the test wheel on the roadway.

4. A method in accordance with claim 2, characterized in that, for the purposes of rolling on the real roadway, the real test wheel is mounted in freely rotatable manner in a tyre noise measuring trailer and the tyre noise measuring trailer is moved on the roadway, whereby the test wheel is in contact with the roadway.

5. A method in accordance with claim 2, characterized in that, for the production of the recording of the tyre rolling noise, at least one sound pressure sensor is used for measuring a prevailing sound pressure.

6. A method in accordance with claim 5, characterized in that, for the recording of the tyre rolling noise, at least one sound pressure sensor is arranged on an outer side of the test wheel.

7. A method in accordance with claim 5, characterized in that, for the recording of the tyre rolling noise, at least one sound pressure sensor is arranged in front of the test wheel.

8. A method in accordance with claim 5, characterized in that, for the recording of the tyre rolling noise, at least one sound pressure sensor is arranged behind the test wheel.

9. A method in accordance with claim 5, characterized in that a microphone is used as the sound pressure sensor.

10. A method in accordance with claim 1, characterized in that the recording of the tyre rolling noise that has been produced is stored on a storage medium.

11. A method in accordance with claim 2, characterized in that the recording of the tyre rolling noise is produced in the form of a real or simulated test sound field data record, and in that the test sound field data record contains data for at least one spatial point of the test sound field in the vicinity of the test wheel rolling on a roadway for the purposes of describing the test sound field produced in the vicinity of the test wheel by the rolling of the test wheel on the roadway.

12. A method in accordance with claim 11, characterized in that the test sound field data record contains data for describing the sound pressure of the test sound field prevailing at the at least one spatial point of the test sound field.

13. A method in accordance with claim 1, characterized in that a simulation sound field in the vicinity of the at least one wheel arranged on the vehicle being measured and an internal sound field in the interior of the vehicle are produced by the reproduction of the recording of the tyre rolling noise, and in that the noise component that is to be determined is determined by measuring the internal sound field at the at least one internal spatial point.

14. A method in accordance with claim 1, characterized in that the simulation sound field is produced by at least one tyre rolling noise reproduction device which is arranged in the vicinity of the at least one wheel.

15. A method in accordance with claim 14, characterized in that at least one tyre rolling noise reproduction device is arranged in such a manner that the sound produced during the reproduction of the recording of the tyre rolling noise is radiated outwardly from the at least one wheel in a direction transverse to the direction of travel.

16. A method in accordance with claim 14, characterized in that at least one tyre rolling noise reproduction device is arranged in such a manner that the sound produced during the reproduction of the recording of the tyre rolling noise is radiated away from the at least one wheel in the direction of travel.

17. A method in accordance with claim 14, characterized in that at least one tyre rolling noise reproduction device is arranged in such a manner that the sound produced during the reproduction of the recording of the tyre rolling noise is radiated away from the at least one wheel in a direction opposite to the direction of travel.

18. A method in accordance with claim 14, characterized in that three or four tyre rolling noise reproduction devices per wheel are used.

19. A method in accordance with claim 14, characterized in that a point-like emitter or a substantially point-like emitter is used as the tyre rolling noise reproduction device.

20. A method in accordance with claim 14, characterized in that a loudspeaker is used as the tyre rolling noise reproduction device.

21. A method in accordance with claim 1, characterized in that the reproduction of the recording of the tyre rolling noise is recorded in the form of a recording of the reproduction of the tyre rolling noise, and in that the reproduction of the recording of the tyre rolling noise is calibrated in such a manner that the recording of the reproduction of the tyre rolling noise coincides with the recording of the tyre rolling noise.

22. A method in accordance with claim 21, characterized in that the calibration of the recording of the reproduction of the tyre rolling noise is carried out using a wheel, and in that the wheel is arranged on the vehicle for the calibration process.

23. A method in accordance with claim 21, characterized in that the calibration of the recording of the reproduction of the tyre rolling noise is carried out using a wheel, and in that the wheel is removed from the vehicle for the calibration process.

24. A method in accordance with claim 21, characterized in that the recording of the reproduction of the tyre rolling noise is produced in the form of a calibration sound field data record which, for the purposes of describing the simulation sound field, contains data for at least one spatial point of the simulation sound field in the vicinity of the wheel.

25. A method in accordance with claim 21, characterized in that, for the purposes of producing the recording of the reproduction of the tyre rolling noise, at least one simulation sound field sound pressure sensor is used for measuring a sound pressure prevailing at at least one spatial point of the simulation sound field in the simulation sound field.

26. A method in accordance with claim 24, characterized in that the at least one spatial point of the simulation sound field has the same spatial relationship relative to the wheel as does the at least one spatial point of the test sound field relative to the test wheel.

27. A method in accordance with claim 21, characterized in that the tyre rolling noise reproduction device is calibrated by altering the simulation sound field until the calibration sound field data record corresponds to the test sound field data record.

28. A method in accordance with claim 25, characterized in that the at least one simulation sound field sound pressure sensor is arranged in the same spatial relationship relative to the wheel as is the at least one sound pressure sensor relative to the test wheel.

29. A method in accordance with claim 25, characterized in that the at least one simulation sound field sound pressure sensor and the at least one sound pressure sensor are identical or of similar construction.

30. A method in accordance with claim 25, characterized in that three or four sound pressure sensors and three or four simulation sound field sound pressure sensors are used.

31. A method in accordance with claim 13, characterized in that an internal sound field data record is produced which contains data for the purposes of describing the internal sound field at the at least one internal spatial point.

32. A method in accordance with claim 1, characterized in that the reproduction of the recording of the tyre rolling noise is carried out successively in the vicinity of all the wheels of the vehicle, in that an internal noise component is thereby determined individually for each wheel, and in that the noise component being determined is obtained by the addition of the internal noise components of the individual wheels.

33. A method in accordance with claim 1, characterized in that the reproduction of the recording of the tyre rolling noise is carried out simultaneously in the vicinity of at least two wheels of the vehicle, in that an internal noise component is thereby determined for the at least two wheels together, and in that the noise component that is to be determined and which results from all the wheels is obtained by the addition of the internal noise components of the at least two wheels.

34. A method in accordance with claim 1, characterized in that the at least one internal spatial point corresponds to the position of the left ear of the front seat passenger or the position of the right ear of the driver.

35. A method in accordance with claim 1, characterized in that a vehicle having four wheels is made available.

36. A method in accordance with claim 1, characterized in that identical wheels are arranged on the vehicle.

37. A method in accordance with claim 1, characterized in that a motor vehicle is used as the vehicle.

38. A method in accordance with claim 2, characterized in that a multiplicity of different recordings of tyre rolling noise is produced for different combinations of test wheels and roadways.

39. A method in accordance with claim 2, characterized in that the test wheel or a wheel of similar construction to the test wheel is used as the at least one wheel.

40. A system for determining a noise component, which ensues from the rolling of a wheel of a vehicle on a roadway, in the total noise in the interior of the vehicle, comprising at least one recording of the tyre rolling noise, a tyre rolling noise reproduction device for reproducing the recording of the tyre rolling noise in the vicinity of at least one wheel arranged on the vehicle being measured, and a measuring device for measuring the noise component that is to be determined at at least one internal spatial point in the interior of the vehicle during the reproduction of the recording of the tyre rolling noise.

41. A system in accordance with claim 40, characterized in that the system comprises a tyre rolling noise recording device for producing the recording of the tyre rolling noise by recording real or simulated rolling noises which occur in the vicinity of the test wheel during the real or simulated rolling of a real or simulated test wheel on a real or simulated roadway.

42. A system in accordance with claim 41, characterized in that the recording of the tyre rolling noise is producible with the aid of the tyre rolling noise recording device by recording the rolling noises in dependence on the rolling speed of the test wheel on the roadway.

43. A system in accordance with claim 42, characterized in that the tyre rolling noise recording device comprises a tyre noise measuring trailer in which the real test wheel is adapted to be mounted in freely rotatable manner for the purposes of rolling on the real roadway.

44. A system in accordance with claim 42, characterized in that the tyre rolling noise recording device comprises at least one sound pressure sensor for measuring a prevailing sound pressure.

45. A system in accordance with claim 44, characterized in that the at least one sound pressure sensor is arranged on an outer side of the test wheel.

46. A system in accordance with claim 44, characterized in that the at least one sound pressure sensor is arranged in front of the test wheel.

47. A system in accordance with claim 44, characterized in that the at least one sound pressure sensor is arranged behind the test wheel.

48. A system in accordance with claim 44, characterized in that the at least one sound pressure sensor is a microphone.

49. A system in accordance with claim 40, characterized in that the system comprises at least one storage medium for storing the recording of the tyre rolling noise that has been produced.

50. A system in accordance with claim 40, characterized in that the system comprises a data processing arrangement for recording, reproducing and/or processing the at least one recording of the tyre rolling noise.

51. A system in accordance with claim 40, characterized in that the system comprises at least one converter unit with which analogue noise data is convertible into digital noise data and/or vice versa.

52. A system in accordance with claim 40, characterized in that the at least one tyre rolling noise reproduction device is arranged in such a manner that the sound produced during the reproduction of the recording of the tyre rolling noise is radiated outwardly from the at least one wheel in a direction transverse to the direction of travel.

53. A system in accordance with claim 40, characterized in that at least one tyre rolling noise reproduction device is arranged in such a manner that the sound produced during the reproduction of the recording of the tyre rolling noise is radiated away from the at least one wheel in the direction of travel.

54. A system in accordance with claim 40, characterized in that at least one tyre rolling noise reproduction device is arranged in such a manner that the sound produced during the reproduction of the recording of the tyre rolling noise is radiated away from the at least one wheel in a direction opposite to the direction of travel.

55. A system in accordance with claim 40, characterized in that three or four tyre rolling noise reproduction devices per wheel are provided.

56. A system in accordance with claim 40, characterized in that the at least one tyre rolling noise reproduction device comprises a point-like emitter or a substantially point-like emitter.

57. A system in accordance with claim 40, characterized in that the at least one tyre rolling noise reproduction device comprises a loudspeaker.

58. A system in accordance with claim 40, characterized in that the system comprises a tyre rolling noise reproduction recording device for recording the reproduction of the recording of the tyre rolling noise in the form of a recording of the reproduction of the tyre rolling noise, and in that a calibration unit is provided for calibrating the tyre rolling noise reproduction device so that the recording of the reproduction of the tyre rolling noise coincides with the recording of the tyre rolling noise.

59. A system in accordance with claim 58, characterized in that the system comprises at least one simulation sound field sound pressure sensor for the production of the recording of the reproduction of the tyre rolling noise.

60. A system in accordance with claim 59, characterized in that the at least one simulation sound field sound pressure sensor is arranged with the same spatial relationship relative to the wheel as that of the at least one sound pressure sensor relative to the test wheel.

61. A system in accordance with claim 59, characterized in that the at least one simulation sound field sound pressure sensor and the at least one sound pressure sensor are identical or of similar construction.

62. A system in accordance with claim 59, characterized in that the system comprises three or four sound pressure sensors and three or four simulation sound field sound pressure sensors.

63. A system in accordance with claim 40, characterized in that the measuring device is arranged in the interior in such a manner that the noise component can be measured at a position which corresponds to the left ear of the front seat passenger or the right ear of the driver.

64. A system in accordance with claim 40, characterized in that the vehicle comprises four wheels.

65. A system in accordance with claim 40, characterized in that identical wheels are arranged on the vehicle.

66. A system in accordance with claim 40, characterized in that the vehicle is a motor vehicle.

67. A system in accordance with claim 41, characterized in that the system comprises a multiplicity of different recordings of the tyre rolling noise incorporating noise data for different combinations of test wheels and roadways.

68. A system in accordance with claim 41, characterized in that the at least one wheel is the test wheel or a wheel of similar construction to the test wheel.

69. A system in accordance with claim 40, characterized in that a method in accordance with any of the claims 1 to 39 is capable of being effected by this system.
